(19) United States
(12) Patent Application Publication
(10) Pub. No.: US 2009/0256067 A1
(43) Pub. Date: Oct. 15, 2009

(54) Electron capture dissociation in radiofrequency ion traps

(76) Inventor: Jack A. Syage, Huntington Beach, CA (US)

Correspondence Address: Irell & Manella LLP, Ste. 900, 1800 Avenue of the Stars, Los Angeles, CA, 90067-4276, US

(21) Appl. No.: 12/082,536

(22) Filed: Apr. 10, 2008

(51) Int. Cl. B01D 59/44

(52) U.S. Cl. 250/281; 250/282

(57) ABSTRACT

A system and method that includes injecting low-energy electrons in a radiofrequency (RF) ion trap in order to dissociate positive ions by electron capture. The system includes an ion trap, a controller to provide RF that can be switched on and off rapidly, and a source of low-energy electrons that can be turned on and off synchronously with the radiofrequency on/off periods.

### BACKGROUND OF THE INVENTION

1. Field of the Invention

The present invention relates to a device and method for achieving electron capture dissociation in radiofrequency ion traps in order to effect selective dissociation of molecular ions.

2. Background Information

Mass spectrometry (MS) analysis of proteins and peptides is a critical function in proteomic studies. MS instrumentation enables selective ion fragmentation that can give structure and sequence information of peptides and proteins leading to identification and in some cases the function of protein in cellular processes. The principal means of achieving sequence information is by collision-induced dissociation (CID) using ion trap, triple quadrupole, or fourier transform MS systems. This method delivers moderate energy to ions, which then undergoes energy randomization to create many chemical bonds. Consequently only the weakest bonds tend to dissociate by CID. Also as molecules increase in size (e.g., proteins), energy randomization becomes so extensive that there is not sufficient energy in any particular bond to cause it to break. Although CID is effective at fragmenting peptides, the bond breaking is generally only along the amide N-C(O) bond generating the so-called b (N-terminal) and y (C-terminal) series as illustrated in FIG. 1.

Electron capture dissociation (ECD) is a method of fragmenting peptide and protein bonds in a manner that can give information on post-translational modifications (PTMs). Fragmentation by CID often leads to neutral loss of PTM sites complicating the identification of the sequence and the location of the PTM group. ECD is based on the recombination of a low-energy electron (e.g., <1 eV) with a protonated (or multiply protonated) peptide or protein as illustrated in FIG. 2 and, which generates considerable energy localized in specific bonds. The process does not seem to lead to energy randomization, but instead preferentially fragments the N-C(R) bonds (also referred to as N-Cα) generating the c and z ion series as shown in FIG. 1. Furthermore, the dissociation occurs with similar efficiency regardless of the amino acid residue on either side of the bond (except for diminuation for N-terminal praline).

ECD is difficult to implement in radiofrequency (RF) driven mass analyzers, such as quadrupole and linear ion traps (QIT and LIT, respectively) because the RF fields accelerate the electrons to energies that greatly exceed what is needed for efficient ECD. ECD has therefore been most successfully employed in FT MS systems where ion containment is achieved by magnetic fields, which impart orbital motion on electrons, but do not accelerate them to higher energy. A complementary method called electron transfer dissociation (ETD) has been developed for RF ion traps and is based on delivering a beam of negative ions and allowing them to transfer an electron through recombination with protonated peptides and proteins to induce dissociation. Because of the added complexity and inefficiency of generating a negative ion beam, it is greatly desirable to develop an ECD method for RF ion traps.

There is a great need to develop ECD methods for RF driven ion traps for several reasons: (i) they are commonly used in proteomics research, (ii) they have much faster analysis times than FT MS systems, which is important for high-speed chromatographic techniques, and (iii) they are more economical than FT MS.

There are three prior art techniques for performing ECD in RF ion traps, each of which attempts to inject and maintain low-energy electrons in the trap for sufficient periods of time for useful reaction with positive ions to occur. Silivra et al. injected low-energy electrons into a quadrupole ion trap (QIT) at the beginning of the positive RF semi-period and trapped the electrons with an axial magnetic field by installing permanent magnets inside the ring electrode. The difficulty of this method is that the electrons remain cool for less than one period of the ring electrode RF (i.e., about 1 microsecond) resulting in inefficient ECD and reactions leading to undesired fragmentation.

Ding and Brancia developed a technique for avoiding the accelerating effect of the RF field on the electron energy. They used a square wave generator for the RF ring electrode trapping potential of a QIT, which they termed a digital ion trap. The benefit is that the potential in the ion trap is non-varying except during the step voltage change at each half cycle. These investigators then injected low energy electrons during the low voltage phase of the digital waveform. No magnet is needed by this method; however, the electrons were injected well outside the ion trap, which made it difficult to decelerate and localize the electrons at the center of the ion trap. Consequently, very long ECD interaction times (e.g., 400 ms/scan×250 scans=100 s) were required, which is not amenable to use with chromatography.

U.S. Patent Application 20060169892 filed by Baba et al., achieved ECD using a linear ion trap (LIT) and a magnetic field. Unlike a QIT, the center axis of a LIT is at zero potential. By using a magnetic field and an electron emitter at one end of the linear trap, these investigators succeeded in injecting a sufficiently high density of low-energy electrons to obtain efficient ECD as measured by reaction times of only a few milliseconds. A disadvantage of this method is complexity as it required a second linear ion trap positioned orthogonal to the ion path leading to the TOFMS, as well as the use of a permanent magnet.

Other approaches to ECD in mass spectrometers have been patented. U.S. Pat. No. 6,858,840 issued to Berkout et al. disclose a technique of performing ECD in multiple ion guides, in which electrons are injected into an RF ion guide and the most effective electron energy occurs during a very small fraction of the RF oscillation period. The Berkout patent also discloses using square waves for the RF so that the electric field is constant for a larger fraction of the RF period. This approach is similar to that used by Ding and Brancia in their digital ion trap.

U.S. Pat. Nos. 6,919,562 and 7,049,584 issued to Whitehouse et al. also disclose a technique of performing ECD in multiple ion guides by taking advantage of electron velocity reversals (e.g., slow down and turn around) occurring in the RF field. The electrons then have momentary zero velocity to react with ions by ECD. However, in this method the effective reaction times are very short because of the immediate reacceleration of the electrons in the RF field. These inventors also disclose using a magnet to help contain the electrons in the reactive volume.

U.S. Pat. No. 6,924,478 issued to Zubarev discloses a technique to perform ECD in an ion trap in which electrons are injected and some ion fragmentation occurs and then vibrational excitation is added to achieve further ion fragmentation. The patent discloses that the RF field in the ion trap or ion guide will accelerate the electrons and create high energy electron capture dissociation. However, this method does not give the selective N—Ca bond breakage that gives the informative c and z series of peptide ion fragments shown in FIG. 1.

U.S. Pat. No. 7,227,133 issued to Glish et al. disclose a technique for performing ECD in a magnetic trap followed by mass analysis. This patent does not provide disclosures for performing ECD in an RF ion trap or ion guide.

### BRIEF SUMMARY OF THE INVENTION

A detector system that has an ion trap coupled to a electron source and a detector. The system includes a controller coupled to the ion trap and the electron source to turn the ion trap and the electron source on and off, such that the electron source is on when the ion trap is off.

### BRIEF DESCRIPTION OF THE DRAWINGS

FIG. 1 is a diagram for a specific bond breaking that can occur in a peptide or protein in the prior art;

FIG. 2 is an illustration of a process of electron capture dissociation by a positive ion leading to dissociation to fragment ions;

FIG. 3A is a schematic of a QIT with an electron emission source;

FIG. 3B is an enlarged view of the QIT shown in FIG. 3B;

FIG. 4 is a timing diagram of the RF amplitude and the electron emission source for a QIT device;

FIG. 5 is a timing diagram of the RF amplitude and the electron emission source for a QIT TOF device;

FIG. 6 is an oscilloscope trace of an RF waveform that can be turned off precisely on a zero voltage crossing;

FIG. 7A is a schematic of a QIT with a photon source for photoelectron emission;

FIG. 7B is an enlarged view of the QIT shown in 4A;

FIG. 8 is a schematic of a QIT with a pulsed photon source for photoelectron emission;

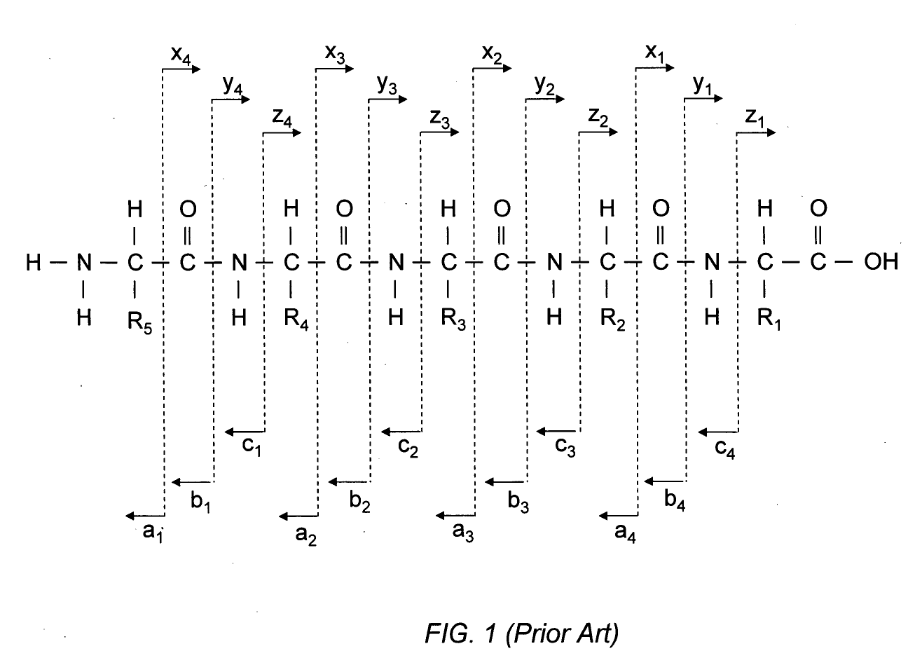

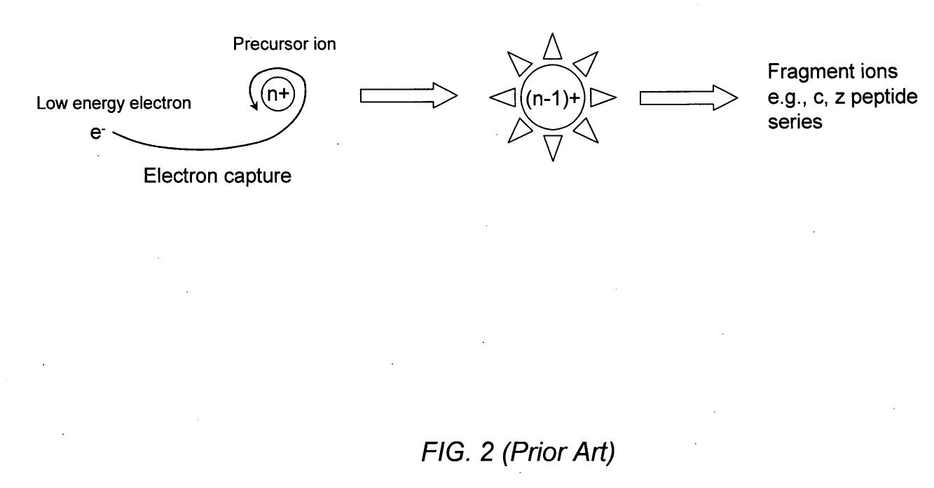

### DETAILED DESCRIPTION OF THE PREFERRED EMBODIMENT

Disclosed is a system and method that includes injecting low-energy electrons in a radiofrequency (RF) ion trap in order to dissociate positive ions by electron capture. The system includes an ion trap, a controller to provide RF that can be switched on and off rapidly, and a source of low-energy electrons that can be turned on and off synchronously with the radiofrequency on/off periods. The RF can be applied to the ring electrode of a QIT and to the linear electrodes of a LIT. The disclosed method can be used with other ion multiple guides that operate with RF. It can also be applied to QIT, LIT, and other multiple ion guides that serve for ion storage only and also for mass analysis.

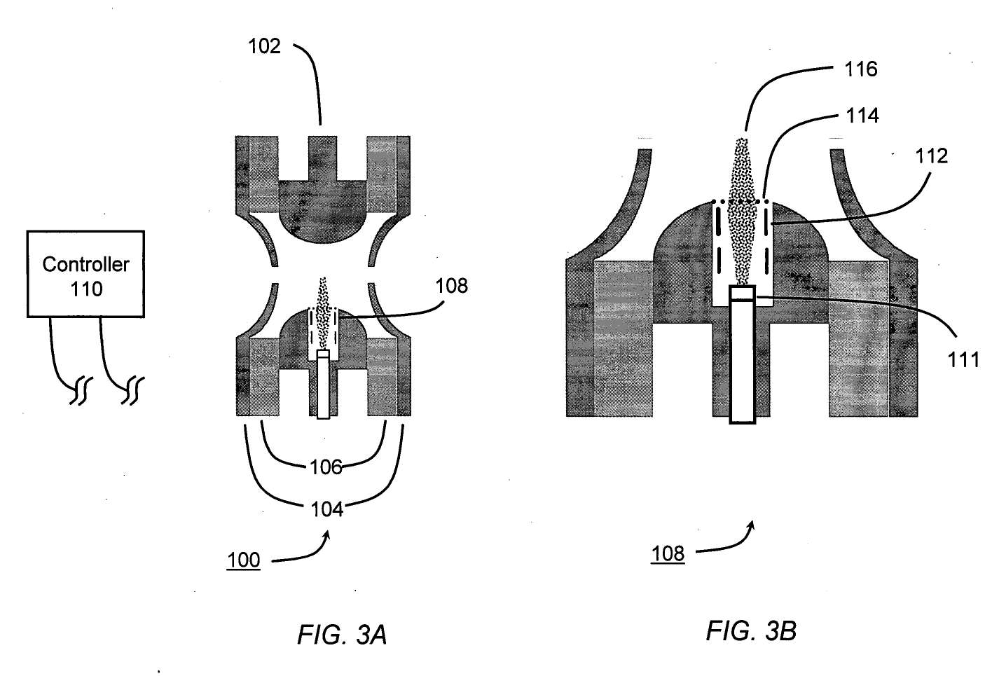

In order to deliver a beam of low-energy electrons into an ion trap it is necessary to have a constant voltage potential in the region of greatest ion density so that the electrons are not accelerated. This can be achieved by turning the RF applied to the ion trap momentarily off and turning on the electron beam during the off period. FIG. 3A shows a QIT 100 with a ring electrode 102, endcap electrodes 104, and non-conducting spacers 106 to help maintain the proper pressure in the QIT, which is typically about 1 mtorr. The QIT also has an electron source assembly 108 with electrostatic lenses to gate the beam on and off and to focus the beam to a specific location. The system may include a controller 110 that controls the electron source 108 and the application of a voltage in the trap.

FIG. 3B shows an expanded view of the electron source assembly 108. The assembly 108 may include an electron emission surface 111, electron focusing electrodes 112, and a gating grid 114, which has a switchable electric field to allow electrons to transmit through the grid. The assembly 108 generates a transmitted low-energy electron beam 116 focused to the center of the QIT 100. Other electric field elements could be used to achieve the same effects. Also other electron sources can be used besides a surface electron emission source such as a hot filament, cold cathode or other material.

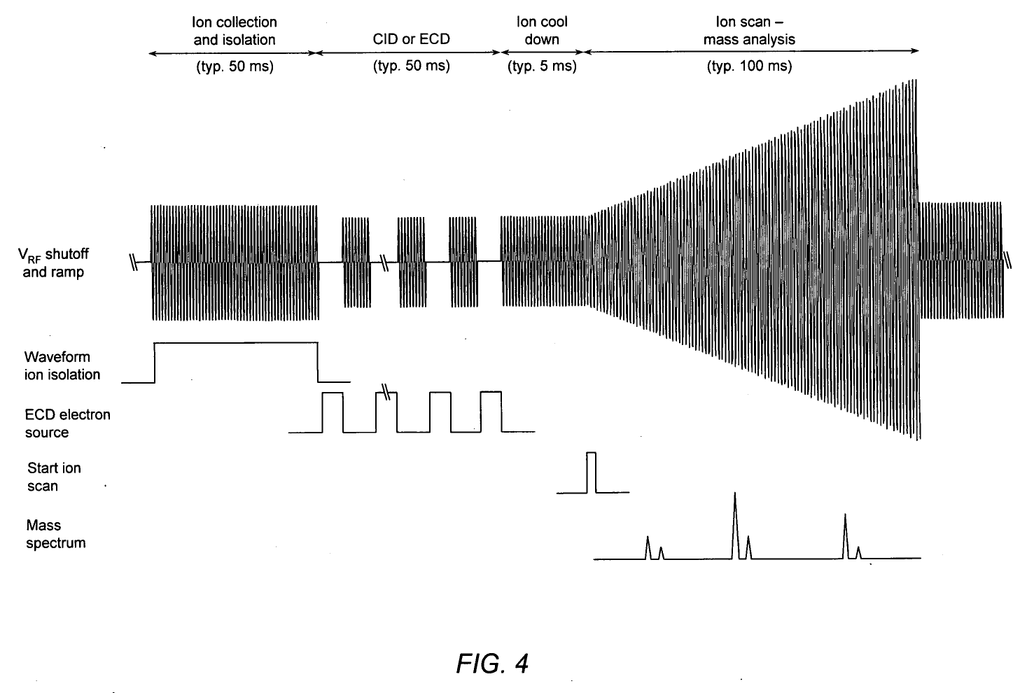

FIG. 4 shows the timing diagram for all functions of QIT ion storage, ion isolation, ECD, and mass-selective instability scan out for mass analysis. The timing diagram can be performed by the controller 110.

The steps involved in an MS/MS scan using ECD are:

(i) Ion collection/isolation: Ions are allowed to enter the QIT while an oscillating voltage is applied to the endcaps 104 to destabilize all but one ion mass-to-charge (m/z) value in a standard QIT mass isolation mode. This MS/MS step is usually preceded by a MS survey scan that determines what ions are present and a determination of what m/z value to store for further dissociation.

(ii) CID or ECD: For standard CID, an oscillating voltage is applied to the endcaps 104 to energize the stored ions and cause them to dissociate. In this case the RF applied to the ring electrode 102 remains on, although its value may be varied from that of the ion collection/isolation step in order to optimize the stabilization of the fragment ions. As shown in FIG. 4 the V_{RF} amplitude is typically decreased from the ion collection and isolation period in order to store the lower ion fragment masses. In the disclosed ECD mode, the RF voltage is turned on and off for periods of time that are sufficient to introduce the electron beam into the QIT and achieve ECD as well as to retrap the ions that are momentarily free to drift during the RF off period. In the embodiment shown, the duty cycle is about 50%, which will lead to efficient conversion of the parent ion to ECD fragment ions. Other duty cycles can be used, but would typically be between 10-90%.

(iii) Ion cool down: This step may or may not be necessary, but there may be a period of subsequent ion cooling prior to mass analysis in the QIT.

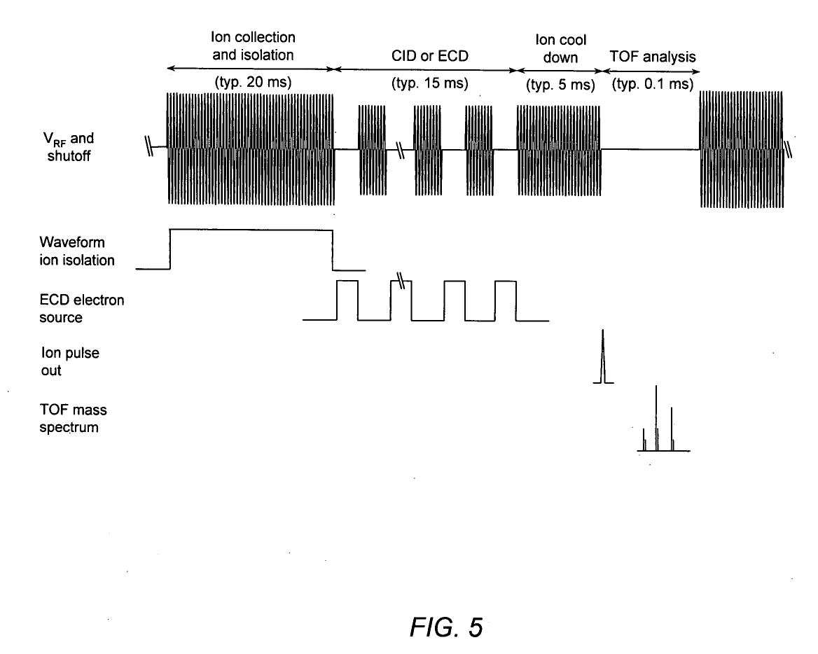

(iv) Mass analysis: For conventional QIT MS, the RF on the ring electrode 102 stays on as the ions are scanned out of the QIT. This is achieved by ramping the RF amplitude. Other methods can also be used including an auxiliary field on the endcaps 104 or ring electrodes 102 or a combination of auxillary fields and ramping of the RF amplitude on the ring electrode 102. A similar timing diagram is given in FIG. 5 for the QIT TOF MS mode. In this case the RF on the ring electrode 102 is turned off and the ions are extracted by positive and negative high voltage ion pulse outs applied to the endcap electrodes 104. The TOF mass spectrum takes only about 100 μs to record, after which the RF field is restored and the next MS or MS/MS cycle occurs.

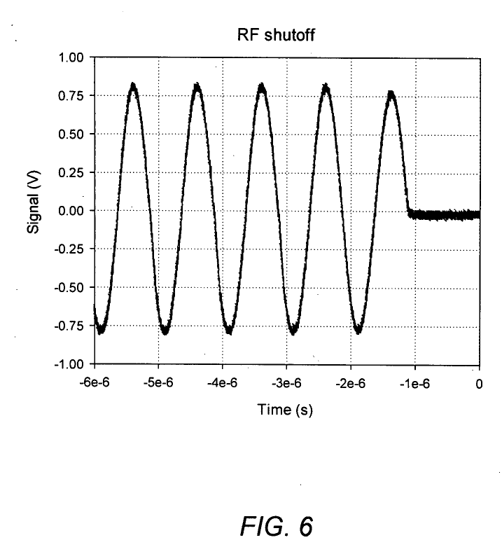

The disclosed method for performing ECD in a QIT device also enables the combination of ECD and CID to be performed. This can be done on successive scans or it can be done on the same scan by applying CID excitation waveforms to the endcap electrodes 102 by conventional methods. FIG. 6 shows an example of the capability to shut off the RF voltage instantaneously, in this case at the negative going zero crossing.

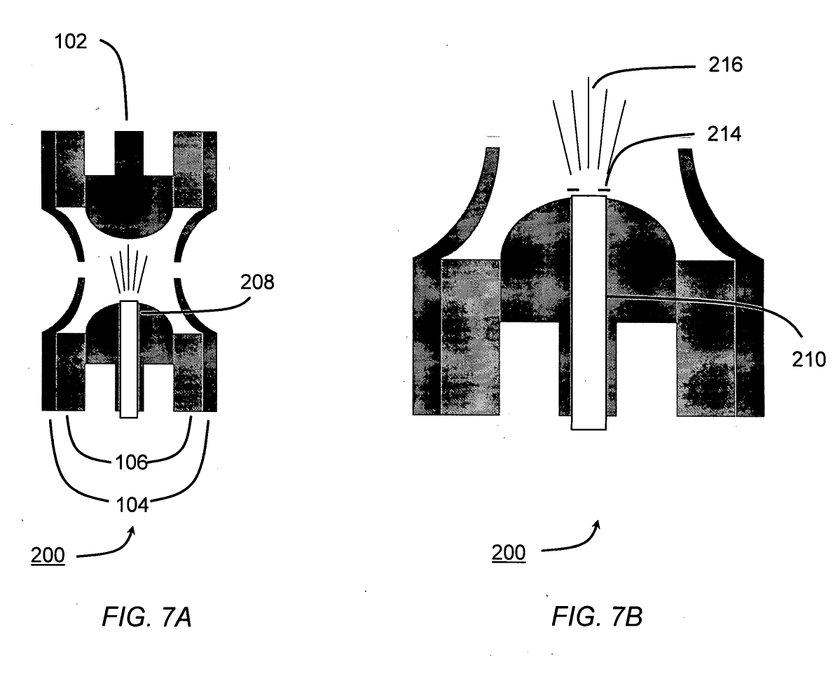

Also disclosed is a system and method to generate low-energy electrons inside the QIT by photoemission. FIG. 7A shows a QIT 200 with an ultraviolet light source (lamp) 208 that radiates photons at an energy higher than the photoemission energy of the metal used for the ring electrode 102. This would typically be about 4 eV and higher. The photoelectron emission energy is given by the equation E=Eₚₕ−Eₜₕ where Eₚₕ is the photon energy and Eₜₕ is the metal or surface material photoemission threshold energy. E can therefore be controlled by choosing the photon energy and would typically be about 1 eV or less, although a wide range of energies (e.g., 0 to 10 eV) are possible. FIG. 7B shows an electrode 214 of the photoemission QIT 200. The path of the photons are represented by 216 and would mostly strike the opposite side of the ring electrode 102. The low-energy electrons can then be directed back toward the center of the QIT where the ion population is greatest using the electric field control of electrode 214. The electrode 214 can be a circular disk or ring or some other geometry. According to the timing diagrams in FIGS. 4 and 5, it would be preferable to turn the lamps on and off synchronously with the ECD RF gating period; however, the light could remain on continuously. In this case the electrons would be accelerated to high energy when the RF is on. This may not have an adverse affect on ion dissociation and may be left on for convenience. It is also possible that high-energy electron ion dissociation and other interactions may be desirable for breaking other bonds in the stored ions. In fact this mode could be made the exclusive mode by timing the light-on periods with the RF-on periods. This mode can also be used with the electron source shown in FIG. 3 to achieve high-energy electron ion dissociation and other interactions.

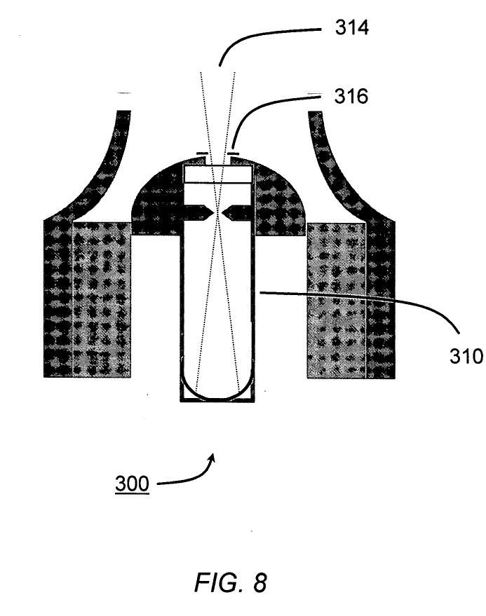

FIG. 8 shows am embodiment of a photoelectron emission configuration 300 that includes a pulsed lamp source 310. It is typical for discharge lamps to deliver bursts of photons with a duration of a few microseconds. This would be optimally matched to the RF-off periods shown in FIGS. 4 and 5. The lamp-on periods could also be timed to be on during the RF-off periods to generate low-energy electron interactions or during the RF-on period to generate high-energy electron interactions. The photons represented by path 314 strike metal or other photoelectron emitting surfaces in the QIT. The electrode 316 directs the electrons to regions within the QIT presumably at the center of the QIT where the stored ion density is greatest.

All of the means, methods, and embodiments described within for electron interactions with positive ions also apply to the interaction of positron (electron antiparticle) interactions with negative ions.

The disclosed invention has several advantages compared to existing methods including (i) no need for a permanent magnet, (ii) mechanical simplicity, (iii) efficient coupling of the electron source to the center of the QIT, (iv) high density of electrons and positive ions to enhance reaction rate, (v) opportunity to do rapid switching between CID and ECD and even to do both on the same scan cycle. The disclosed invention is applicable to any QIT or LIT instrument, which is the general embodiment described here. However, also described is a particular embodiment for QIT-TOF, which has the advantage of significantly reduced mass analysis times and enables higher repetition rates for MS/MS analysis.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A detector system, comprising:
an ion trap;
an electron source coupled to said ion trap;
a detector coupled to said ion trap; and,
a controller coupled to said ion trap and said electron source to turn said ion trap and said electron source on and off, such that said electron source is on when said ion trap is off.

2. The system of claim 1, wherein said ion trap includes a ring electrode and a pair of end caps.

3. The system of claim 1, wherein said electron source includes a light source.

4. The system of claim 1, wherein said ion trap applies a radio frequency voltage.

5. The system of claim 1, wherein said ion trap and said electron source are switched on and off a plurality of times.

6. The system of claim 4, wherein said radio frequency voltage is amplitude modulated.

7. The system of claim 1, wherein said ion trap provides an auxiliary voltage at a frequency that dissociates an ion.

8. The system of claim 1, wherein said detector is a mass detector.

9. A detector system, comprising:
an ion trap;
an electron source coupled to said ion trap;
a detector coupled to said ion trap; and,
means for dissociating an ion in said ion trap assembly.

10. The system of claim 9, wherein said ion trap includes a ring electrode and a pair of end caps.

11. The system of claim 9, wherein said electron source includes a light source.

12. The system of claim 9, wherein said ion trap applies a radio frequency voltage.

13. The system of claim 9, wherein said ion trap and said electron source are switched on and off a plurality of times.

14. The system of claim 12, wherein said radio frequency voltage is amplitude modulated.

15. The system of claim 9, wherein said ion trap provides an auxiliary voltage at a frequency that dissociates an ion.

16. The system of claim 9, wherein said detector is a mass detector.

17. A method for detecting a trace molecule in a sample, comprising:
isolating an ion within an ion trap that is turned on;
turning off the ion trap;
introducing electrons into the ion trap while the ion trap is off to dissociate an ion;
ejecting the dissociated ion from the ion trap; and,
detecting a mass of the dissociated ion.

18. The method of claim 17, wherein the ion is dissociated before the ion trap is turned off.

19. The method of claim 17, further comprising isolating a second ion and dissociating the second ion with a voltage potential having a different amplitude.

20. The method of claim 17, wherein the ion trap applies a voltage frequency that selectively traps the ion from a plurality of ions.
